(19) United States
(12) Patent Application Publication
(10) Pub. No.: US 2024/0312720 A1
(43) Pub. Date: Sep. 19, 2024

(54) METHOD FOR MANUFACTURING MULTILAYER CERAMIC ELECTRONIC COMPONENT

(71) Applicant: KYOCERA Corporation, Kyoto-shi (JP)

(72) Inventors: Yuta OKAZAKI, Kirishima-shi (JP); Hirotoshi ETO, Kirishima-shi (JP); Ryota HASUNUMA, Kirishima-shi (JP)

(73) Assignee: KYOCERA Corporation, Kyoto-shi (JP)

(21) Appl. No.: 18/598,206

(22) Filed: Mar. 7, 2024

(30) Foreign Application Priority Data
Mar. 16, 2023 (JP) 2023-042079

(51) Int. Cl. H01G 4/30

(52) U.S. Cl. CPC H01G 4/30

(57) ABSTRACT

A method for manufacturing a multilayer ceramic electronic component includes a first process, a second process, a third process, and a fourth process. In the first process, a stack of a plurality of ceramic sheets and a plurality of conductors alternately stacked on one another is prepared. In the second process, the stack is cut into stack pieces each including a side surface on which the plurality of conductors is exposed. In the third process, the side surface of each of the stack pieces is etched by irradiation with plasma ions accelerated under a reduced pressure. In the fourth process, a side margin containing a ceramic dielectric is formed on the side surface of each of the stack pieces after the etching.

### TECHNICAL FIELD

### Reference to Related Application

This application claims priority to Japanese Patent Application No. 2023-042079 filed on Mar. 16, 2023, the entire disclosure of which is incorporated herein by reference.

### BACKGROUND OF INVENTION

### Technical Problem

The present invention relates to a method for manufacturing a multilayer ceramic electronic component.

### Description of Related Art

A known method for manufacturing a multilayer ceramic capacitor is described in, for example, Patent Literature 1 (Japanese Unexamined Patent Application Publication No. 2012-209539).

### SUMMARY OF THE INVENTION

In one embodiment of the present disclosure, a method for manufacturing a multilayer ceramic electronic component includes preparing a stack of a plurality of ceramic sheets and a plurality of conductors alternately stacked on one another, cutting the stack into stack pieces each including a side surface on which the plurality of conductors is exposed, etching the side surface of each of the stack pieces by irradiation with plasma ions accelerated under a reduced pressure, and forming a side margin containing a ceramic dielectric on the side surface of each of the stack pieces after the etching.

### BRIEF DESCRIPTION OF THE DRAWINGS

The objects, features, and advantages of the present disclosure will become more apparent from the following detailed description and the drawings.

FIG. 1 is a schematic diagram of a multilayer ceramic electronic component according to one embodiment of the present disclosure.

FIG. 2A is a schematic diagram of a component body in the embodiment of the present disclosure, and FIG. 2B is a schematic diagram of the component body with its portions separate from one another.

FIG. 3 is a flowchart of a method for manufacturing a multilayer ceramic electronic component according to the embodiment of the present disclosure.

FIGS. 4A to 4C are schematic diagrams of ceramic sheets and conductors on the ceramic sheets in the embodiment of the present disclosure.

FIG. 5 is a schematic perspective view of a stack in the embodiment of the present disclosure.

FIG. 6 is a schematic perspective view of the stack in the embodiment of the present disclosure.

FIG. 7 is a schematic perspective view of a stack piece in the embodiment of the present disclosure.

FIG. 8 is a partial schematic cross-sectional view of the stack in a second process.

FIGS. 9A and 9B are each a partial schematic cross-sectional view of the stack piece resulting from cutting in the second process.

FIG. 10 is a schematic diagram illustrating a third process.

FIG. 11 is a schematic diagram illustrating a side surface of the stack piece before and after the third process.

FIG. 12 is a schematic diagram illustrating a fourth process.

FIG. 13 is a schematic perspective view of a component body precursor in the embodiment of the present disclosure.

### DESCRIPTION OF THE INVENTION

Recent small and sophisticated electronic devices incorporate smaller and higher-capacity multilayer ceramic capacitors. Such multilayer ceramic capacitors may include enlarged internal electrodes and thinner side margins for insulation around the internal electrodes.

However, typical methods for manufacturing multilayer ceramic capacitors cannot easily achieve side margins with a uniform thickness when, for example, the accuracy in patterning the internal electrodes or cutting a multilayer sheet is low. Such methods for manufacturing multilayer ceramic capacitors cannot easily achieve insulation around the internal electrodes when the side margins are thinner.

For example, Patent Literature 1 describes producing a block including multiple ceramic green sheets and multiple internal electrodes in a pattern, cutting the block into green chips including cut side surfaces on which the internal electrodes are exposed, and attaching a side ceramic green sheet to the cut side surfaces. The method described in Patent Literature 1 can form the side ceramic green sheet with a uniform thickness. A side margin made of such a side ceramic green sheet can achieve insulation around the internal electrodes although the side margin may be thin.

With the method described in Patent Literature 1, the internal electrodes may be pulled and deformed by a cutting blade moving for cutting the green chips. This may cause short-circuiting of the internal electrodes exposed on the cut side surfaces of the green chips.

A multilayer ceramic electronic component 1 and a method for manufacturing the multilayer ceramic electronic component 1 according to one embodiment of the present disclosure will now be described with reference to the drawings. A multilayer ceramic capacitor will now be described as an example of the multilayer ceramic electronic component 1. However, the multilayer ceramic electronic component to be manufactured in the embodiment of the present disclosure is not limited to the multilayer ceramic capacitor, and may be any of various other multilayer ceramic components such as a multilayer piezoelectric element, a multilayer thermistor, a multilayer coil, and a multilayer ceramic substrate.

The drawings used herein are schematic and may not be drawn to scale relative to the actual size of each component. The embodiments described herein are illustrative, and the components in different embodiments or variations may be partly interchanged or combined.

### Structure of Multilayer Ceramic Electronic Component

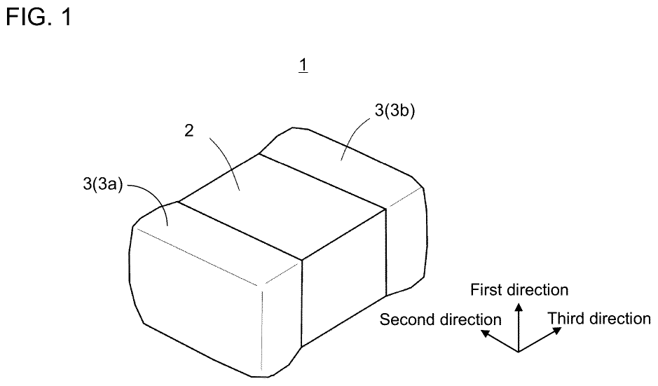

FIG. 1 is a schematic diagram of a multilayer ceramic electronic component 1 according to one embodiment of the present disclosure. The multilayer ceramic electronic component 1 includes a component body 2 and external electrodes 3. The component body 2 is, for example, substantially rectangular, although the component body 2 may have any appropriate shape. The external electrodes 3 may be located, for example, on a pair of end faces of the component body 2 and may extend to other adjacent faces. One of the external electrodes on one end face is an external electrode 3a, and the other external electrode on the other end face is an external electrode 3b.

For ease of explanation, some of the drawings include an orthogonal coordinate system defined by a first direction, a second direction, and a third direction. In one or more embodiments of the present disclosure, any direction of the multilayer ceramic electronic component 1 may be the first direction, the second direction, or the third direction. For ease of explanation, the first direction herein is defined as the stacking direction of internal electrode layers 212 and dielectric layers 211 (described later). The second direction is defined as the direction intersecting with the first direction and substantially parallel to the short sides of the substantially rectangular component body 2. The third direction is defined as the direction intersecting with the second direction and substantially parallel to the long sides of the substantially rectangular component body 2. For ease of explanation, the first direction may be referred to as the vertical direction, the second direction may be referred to as the lateral direction, and the third direction may be referred to as the front-rear direction.

The component body 2 is substantially rectangular and has six surfaces. The component body 2 includes the upper and lower surfaces in the first direction defined as main surfaces, the right and left surfaces in the second direction defined as side surfaces, and the front and rear surfaces in the third direction defined as end faces. The main surfaces, the side surfaces, and the end faces are defined in the same manner for a multilayer portion 21 (described later) included in the component body 2, for a component body precursor 200 before firing (described later), for each stack piece 50 before firing (described later), and for a stack 500 before firing (described later).

The external electrodes 3 are made of a conductive material and serve as terminals of the multilayer ceramic electronic component 1. Examples of the conductive material for the external electrodes 3 include a metal such as nickel (Ni), copper (Cu), palladium (Pd), tin (Sn), zinc (Zn), platinum (Pt), silver (Ag), and gold (Au), and an alloy of any of these metals.

Each external electrode 3 may be single-layered or multilayered. For example, each external electrode 3 may be two-layered with an underlying film and a surface film, or may be three-layered with an underlying film, an intermediate film, and a surface film. The underlying film may be, for example, a baked film of a metal or an alloy containing Ni, Cu, Pd, Pt, Ag, or Au as a main component. The intermediate film may be, for example, a plating film of a metal or an alloy containing Pt, Pd, Au, Cu, or Ni as a main component. The surface film may be, for example, a plating film of a metal or an alloy containing Cu, Sn, Pd, Au, or Zn as a main component.

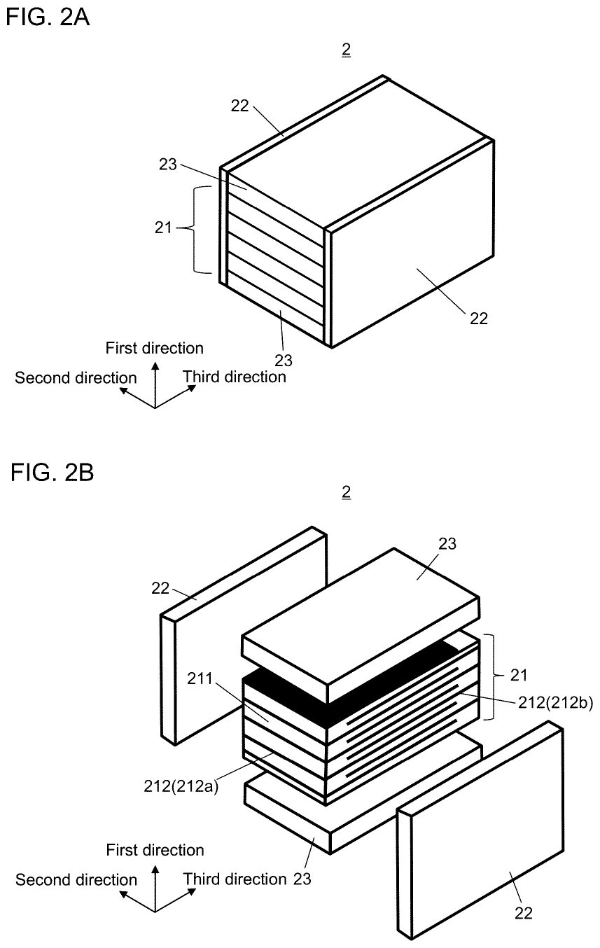

FIGS. 2A and 2B are each a schematic diagram of the component body 2. The component body 2 includes the multilayer portion 21, side margins 22, and covers 23. FIG. 2A is a schematic diagram of the multilayer portion 21, the side margins 22, and the covers 23 joined together. FIG. 2B is a schematic diagram of the multilayer portion 21, the side margins 22, and the covers 23 separate from one another. The component body 2 illustrated in each of FIGS. 2A and 2B can be the component body 2 before firing and can also be the component body 2 after firing. The component body 2 after firing has substantially the same structure as the component body 2 before firing, although being contracted through firing.

The multilayer portion 21 includes the multiple dielectric layers 211 and the multiple internal electrode layers 212 stacked in the first direction. The dielectric layers 211 may contain any of various ceramic dielectrics. For example, the dielectric layers 211 contain barium titanate (BaTiO₃) as a main component. In one or more embodiments of the present disclosure, the main component refers to a component that constitutes higher than or equal to 80% of the total.

The internal electrode layers 212 are connected to the external electrodes 3. The internal electrode layers 212 may contain any of various metals, such as Ni, Pd, Ag, or Cu. For example, the internal electrode layers 212 contain Ni as the main component. The internal electrode layers 212 include internal electrode layers 212a connected to the external electrode 3a and internal electrode layers 212b connected to the external electrode 3b.

The side margins 22 are located on the two side surfaces of the multilayer portion 21 in the second direction. The side margins 22 may contain any of various ceramic dielectrics. For example, the side margins 22 may have the same main component as the dielectric layers 211 in the multilayer portion 21. In this case, the component body 2 can be manufactured with higher efficiency and can be more reliable with reduced internal stress.

The covers 23 are located on the two main surfaces of the multilayer portion 21 in the first direction. The covers 23 may contain any of various ceramic dielectrics. For example, the covers 23 may have the same main component as the dielectric layers 211 in the multilayer portion 21. In this case, the component body 2 can be manufactured with higher efficiency and can be more reliable with reduced internal stress.

In the multilayer ceramic electronic component 1 with the above structure, a voltage is applied to the dielectric layers 211 between the internal electrode layers 212a and the internal electrode layers 212b in response to a voltage applied between the external electrode 3a and the external electrode 3b. The multilayer ceramic electronic component 1 thus stores electric charge corresponding to the voltage between the external electrode 3a and the external electrode 3b.

The multilayer ceramic electronic component 1 may have any known structure appropriate for its intended size or performance. For example, the multilayer portion 21 may include any appropriate number of internal electrode layers 212.

### Method for Manufacturing Multilayer Ceramic Electronic Component

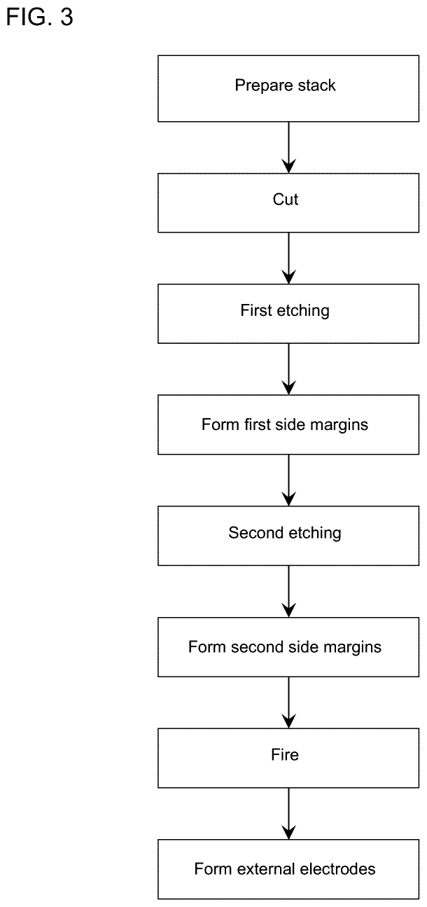

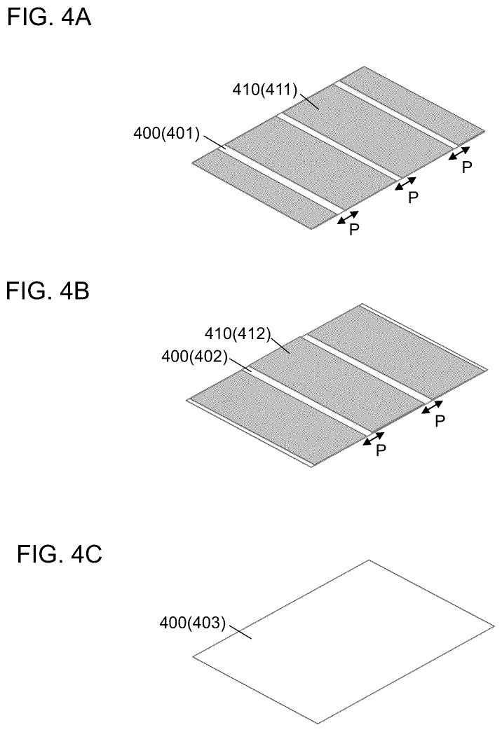

FIG. 3 is a flowchart of a method for manufacturing the multilayer ceramic electronic component 1. FIGS. 4A to 12 are diagrams illustrating the processes for manufacturing the multilayer ceramic electronic component 1. A method for manufacturing the multilayer ceramic electronic component 1 will now be described with reference to FIGS. 4A to 12.

### Preparing Stack in First Process

In the first process, the stack 500 including multiple ceramic sheets 400 and multiple conductors 410 alternately stacked on one another is prepared.

First ceramic sheets 401, second ceramic sheets 402, third ceramic sheets 403, first conductors 411, and second conductors 412 are prepared first. The first ceramic sheets 401 and the second ceramic sheets 402 are to be the dielectric layers 211 in the multilayer portion 21 after firing. The third ceramic sheets 403 are to be the covers 23 after firing. The first conductors 411 and the second conductors 412 are to be the internal electrode layers 212 after firing. The first ceramic sheets 401, the second ceramic sheets 402, and the third ceramic sheets 403 may be collectively referred to as the ceramic sheets 400. The first conductors 411 and the second conductors 412 may be collectively referred to as the conductors 410.

FIGS. 4A to 4C illustrate the ceramic sheets 400 and the conductors 410 on the ceramic sheets 400. FIG. 4A illustrates the first ceramic sheet 401 and the first conductors 411. FIG. 4B illustrates the second ceramic sheet 402 and the second conductors 412. FIG. 4C illustrates the third ceramic sheet 403.

For example, each ceramic sheet 400 is placed on a carrier film with a die coater or with any other method such as a doctor blade coater or a gravure coater. Each ceramic sheet 400 may have any appropriate thickness, such as about 1 to 10 μm. The multilayer ceramic electronic component 1 with thinner ceramic sheets can have higher capacitance.

The ceramic sheets 400 may be made of any of various ceramic dielectric materials. For example, the ceramic sheets 400 are prepared by wet-grinding and mixing a ceramic mixture powder containing BaTiO₃ and an additive using a bead mill and by mixing the resultant slurry with a polyvinyl butyral binder, a plasticizer, and an organic solvent.

As illustrated in FIGS. 4A and 4B, the first conductors 411 to be the internal electrode layers 212a after firing are formed at intervals P on each first ceramic sheet 401 prepared as described above. The second conductors 412 to be the internal electrode layers 212b after firing are formed at intervals P on each second ceramic sheet 402. FIGS. 4A and 4B illustrate the conductors 410 containing a metal material to be the internal electrode layers 212 printed in two different conductive patterns with different polarities.

The conductors 410 may be formed by, for example, screen printing or gravure printing. The conductors 410 may be made of any of various metals. More specifically, in one embodiment of the present disclosure, the conductors 410 are made of a conductive paste containing Ni as a main component.

The conductors 410 may not be formed on the third ceramic sheets 403 corresponding to the covers 23 after firing. In some embodiments, for example, the conductors 410 to be dummy internal electrode layers after firing may be formed on the third ceramic sheets 403.

Each conductor 410 may have any appropriate thickness. Each conductor 410 may have a minimum thickness that achieves the functions of the capacitor. This can reduce internal defects resulting from internal stress. For a capacitor with a stack of many layers, for example, each conductor 410 may have a thickness smaller than or equal to 1.0 μm. The intervals P may be determined as appropriate. The intervals P may not be uniform. For example, the intervals P between the first conductors 411 may differ from the intervals P between the second conductors 412.

The first ceramic sheets 401 with the first conductors 411 may be referred to as first sheets, the second ceramic sheets 402 with the second conductors 412 may be referred to as second sheets, and the third ceramic sheets 403 may be referred to as third sheets.

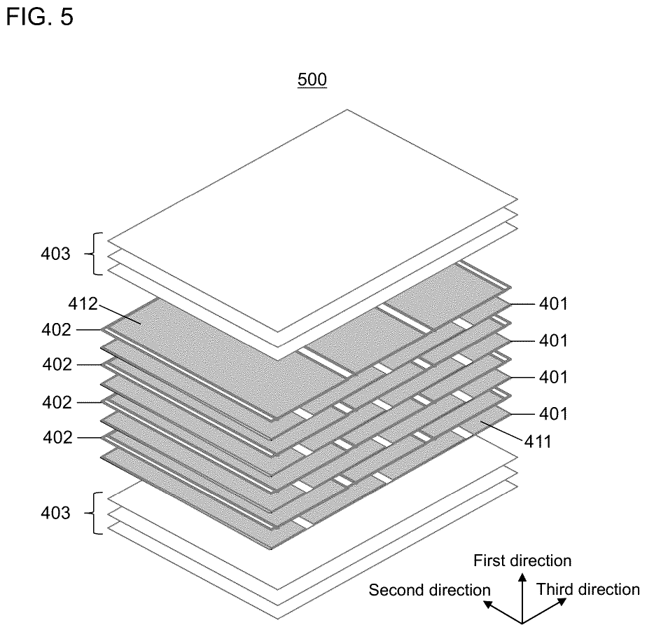

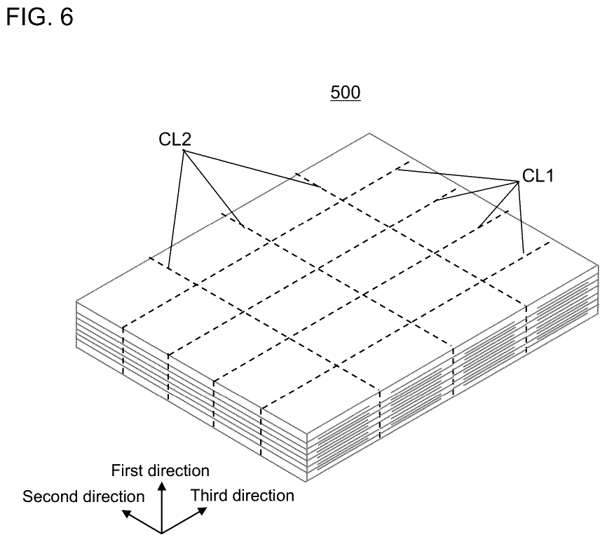

The prepared first, second, and third sheets are stacked on one another into the stack 500. FIG. 5 is a schematic perspective view of the stack 500. For ease of explanation, the ceramic sheets 400 illustrated in FIG. 5 are separate from one another. However, in the actual stack 500, the ceramic sheets 400 are integral with one another as illustrated in FIG. 6 after being pressed with, for example, hydrostatic pressing or uniaxial pressing. The stack 500 with high density is thus obtained.

The stack 500 includes the first and second sheets stacked alternately in the first direction. The first and second sheets correspond to the multilayer portion 21 after firing. The stack 500 also includes sets of third sheets. Each set of third sheets is located on the corresponding one of the uppermost surface or the lowermost surface of the stack of alternate first and second sheets in the first direction. Each set of third sheets corresponds to the cover 23 after firing. Although three third sheets are included in each set in the example in FIG. 5, any appropriate number of third sheets may be included in each set.

### Cutting in Second Process

In the second process, the stack 500 is cut into pieces each including side surfaces and end faces on which the conductors are exposed.

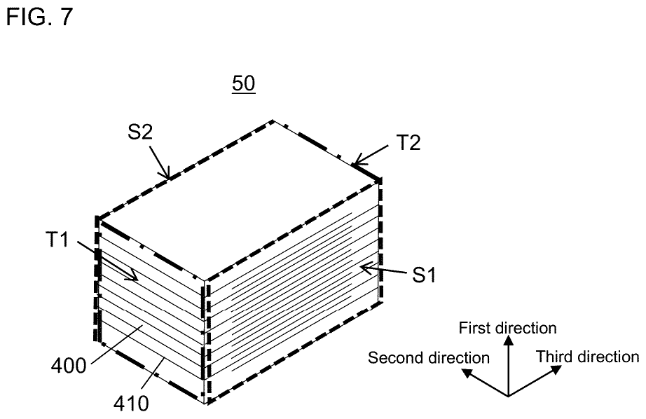

The stack 500 obtained in the first process is cut with press cutting into unfired stack pieces 50. FIG. 6 is a perspective view of the stack 500. The stack 500 is attached to tape as a holder and cut along lines CL1 and CL2. This separates the stack 500 into the stack pieces 50, one of which is illustrated in FIG. 7.

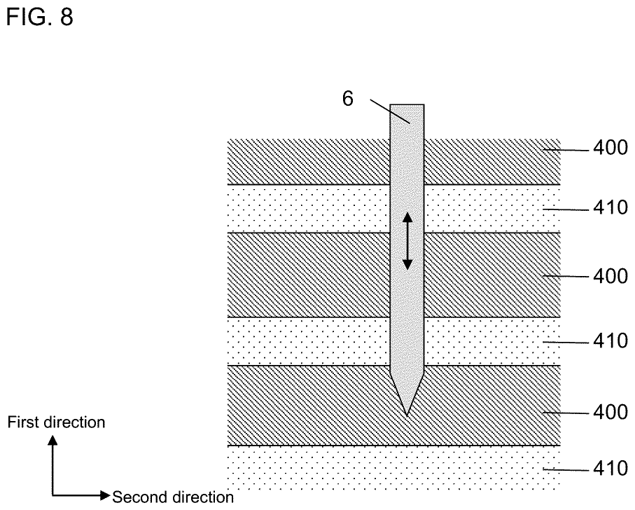

FIG. 8 is a partial schematic cross-sectional view of the stack 500 in the second process. FIG. 8 is a cross-sectional view of the stack 500 as viewed in the third direction. The second process uses a cutter including a cutting blade 6 for cutting. As illustrated in FIG. 8, the cutting blade 6 cuts the stack 500 and is then removed from the stack 500. FIG. 8 illustrates an example process of cutting along a line CL1.

The cut surfaces of the stack 500 along the lines CL1 are to be the side surfaces of the stack pieces 50 in the second direction. Each stack piece 50 includes two side surfaces that may be referred to as a side surface S1 and a side surface S2. FIG. 7 illustrates the side surface S1 and the side surface S2 with dashed lines. Each stack piece 50 resulting from the second process includes the side surface S1 and the side surface S2 on which the conductors 410 are exposed.

The cut surfaces of the stack 500 along the lines CL2 are to be the end faces of the stack pieces 50 in the third direction. Each stack piece 50 includes two end faces that may be referred to as an end face T1 and an end face T2. FIG. 7 illustrates the end face T1 and the end face T2 with dot-dash lines. Each stack piece 50 resulting from the second process includes the end faces on which the conductors 410 are exposed.

In the second process, the stack 500 is cut into the multiple stack pieces 50. When the stack 500 is cut, the tape may remain uncut and connecting the stack pieces 50. This allows the multiple stack piece 50 to be processed collectively in subsequent processes, thus improving the manufacturing efficiency.

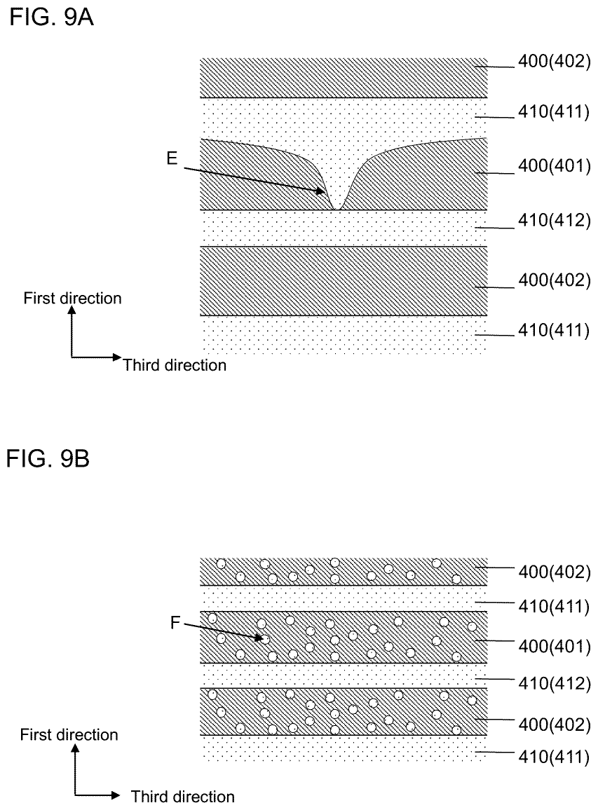

FIGS. 9A and 9B are each a partial schematic cross-sectional view of a stack piece 50 resulting from cutting in the second process. FIGS. 9A and 9B are each a cross-sectional view of the stack piece 50 as viewed in the second direction. Any of the stack pieces 50 resulting from cutting may include a side surface illustrated in FIG. 9A or 9B. The side surfaces in FIGS. 9A and 9B are examples and may be in other conditions.

In the side surface of the stack piece 50 illustrated in FIG. 9A, for example, the conductor 410 includes an extended portion E on the ceramic sheet 400. The extended portion E results from the conductor 410 being pulled and deformed by the cutting blade 6 moving in the second process. When the extended portion E of the first conductor 411 reaches the second conductor 412, for example, the first conductor 411 and the second conductor 412 may be connected together through the extended portion E, possibly causing short-circuiting.

In the side surface of the stack piece 50 illustrated in FIG. 9B, for example, foreign objects F adhere to the ceramic sheet 400. The foreign objects F may be conductive objects produced from, for example, the conductors 410 or the cutting blade 6 in the second process. When many foreign objects F adhere to the side surface, the first conductor 411 and the second conductor 412 may be connected together through the foreign objects F, possibly causing short-circuiting.

In the stack pieces 50 resulting from cutting in the second process, the extended portions E, the foreign objects F, or other such factors may cause short-circuiting between the first conductors 411 and the second conductors 412 exposed on the side surfaces. When the first conductors 411 and the second conductors 412 are short-circuited, the internal electrode layers 212a and the internal electrode layers 212b after firing may also be short-circuited. The multilayer ceramic electronic component 1 with such short-circuiting may have lower performance.

The stack pieces 50 are likely to have short-circuiting between the first conductors 411 and the second conductors 412 on the side surfaces particularly when the internal electrode layers 212a and the internal electrode layers 212b are located at narrow intervals, or in other words, when the ceramic sheets 400 between the first conductors 411 and the second conductors 412 are thin.

The second process may use any technique to cut the stack 500, instead of using press-cutting with the cutting blade 6. For example, a rotary blade may be used. The stack 500 may be cut with a technique without using a blade, such as laser cutting or waterjet cutting. In these cases as well, the stack pieces 50 may have short-circuiting between the first conductors 411 and the second conductors 412 on the side surfaces in the second process.

### First Etching in Third Process

In the third process, the side surface S1, which is one of the two side surfaces of each stack piece 50, is etched by irradiation with plasma ions accelerated under a reduced pressure.

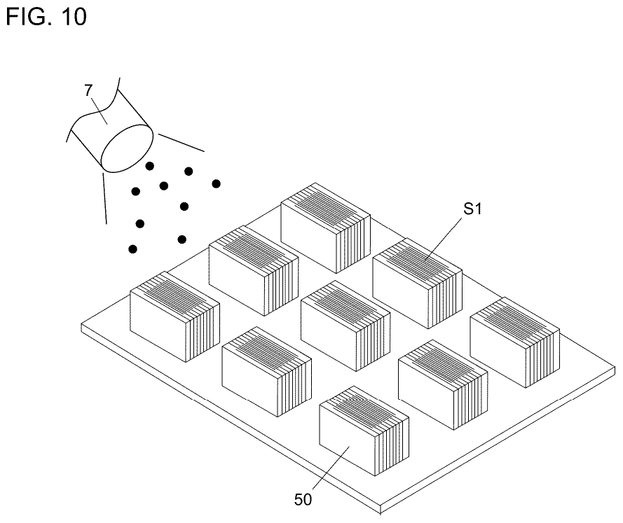

FIG. 10 is a schematic diagram illustrating the third process. As illustrated in FIG. 10, the third process uses a plasma ion irradiator 7 for etching. In the third process, the side surfaces S1 of the stack pieces 50 are irradiated with plasma ions accelerated by the plasma ion irradiator 7. The third process is performed under a reduced pressure. The reduced pressure refers to a pressure lower than the atmospheric pressure, such as a pressure lower than 0.1 MPa.

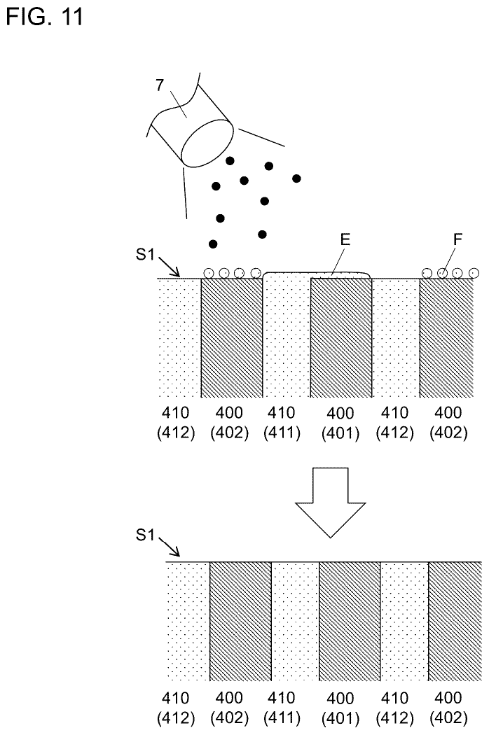

FIG. 11 is a schematic diagram illustrating the side surface S1 of a stack piece 50 before and after the third process. After the second process, the side surfaces S1 can include the extended portions E, the foreign objects F, or other such factors on their surface layers. In the third process, the surface layers of the side surfaces S1 are etched to remove the extended portions E, the foreign objects F, or other such factors. This reduces short-circuiting between the first conductors 411 and the second conductors 412 on the side surfaces S1 of the stack pieces 50. The side surfaces S1 may be etched at any appropriate depth in the second direction.

In the third process, any appropriate plasma ions may be used for irradiation. For example, the plasma ions for irradiation may include inert gas ions. For example, the plasma ions for irradiation include Ar ions. Ar ions, which have a large mass number, can effectively etch the side surfaces of the stack pieces 50. The plasma ions for irradiation are not limited to Ar ions. For example, the plasma ions for irradiation may include He ions, Kr ions, Xe ions, N₂ ions, or O₂ ions.

In the third process, the reduced pressure may be any appropriate pressure. For example, the pressure may be lower than or equal to 0.4 Pa. Under such pressures, the plasma ions for irradiation are less likely to collide with the atmospheric molecules. In other words, the accelerated plasma ions are less likely to decelerate before reaching the side surfaces S1 of the stack pieces 50. The side surfaces S1 of the stack pieces 50 are thus hit by the plasma ions at high speed and can be etched effectively. The reduced pressure may be, for example, lower than or equal to 0.2 Pa. This allows more effective etching of the side surfaces S1 of the stack pieces 50.

In the third process, the plasma ions may be accelerated at any appropriate voltage. For example, the voltage may be higher than or equal to 200 V. When the plasma ions are accelerated at a voltage higher than or equal to 200 V, the side surfaces S1 of the stack pieces 50 are hit by the plasma ions at high speed and can be etched effectively. The voltage may be, for example, higher than or equal to 3000 V. When the plasma ions are accelerated at a voltage higher than or equal to 3000 V, the side surfaces S1 of the stack pieces 50 can be etched more effectively.

The voltage may be, for example, lower than 4000 V. When the plasma ions are accelerated at a voltage higher than or equal to 4000 V, the etch residues may be greatly scattered and are more likely to adhere to the side surfaces S1 of the stack pieces 50 again. Further, when the plasma ions are accelerated at a voltage higher than or equal to 4000 V, the high voltage may charge the side surfaces of the stack pieces 50 with electricity and is more likely to cause the etch residues to adhere to the side surfaces again. A voltage higher than or equal to 4000 Vis thus more likely to cause the etch residues to adhere to the side surfaces again, possibly causing short-circuiting. The voltage may thus be higher than or equal to 200 V and lower than 4000 V, or more specifically, higher than or equal to 3000 V and lower than 4000 V. This allows effective etching with reduced residues adhering to the side surfaces again.

In the third process, the irradiation with plasma ions may be performed for any appropriate time. For example, the irradiation may be performed for 30 to 180 seconds inclusive. The side surfaces of the stack pieces 50 irradiated for 30 to 180 seconds inclusive can be etched more reliably.

In the third process, the irradiation with plasma ions may be performed in any appropriate direction. For example, the irradiation direction may be at an angle with respect to the direction perpendicular to the side surfaces of the stack pieces 50. This reduces etch residues scattered and adhering to the side surfaces again. When the irradiation direction is at an angle with respect to the direction perpendicular to the side surfaces of the stack pieces 50, the etch residues are less likely to be scattered in the traveling direction of the plasma ions. The plasma ions are thus less likely to decelerate. The side surfaces of the stack pieces 50 can thus be etched more effectively with reduced short-circuiting when the irradiation direction is at an angle with respect to the direction perpendicular to the side surfaces. The irradiation direction may be at an angle of, for example, 20 to 70° with respect to the direction perpendicular to the side surfaces, or more specifically, 45°.

### Forming First Side Margins in Fourth Process

In the fourth process, pieces of a side margin sheet 404 containing a ceramic dielectric are formed on the respective side surfaces S1 of the stack pieces 50 after being etched in the third process.

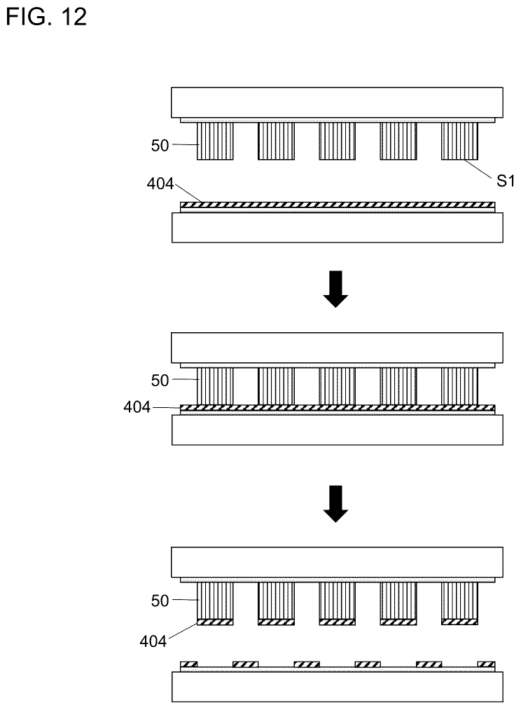

In the fourth process, the side margin sheet 404 to be the side margins 22 after firing is prepared first. FIG. 12 is a schematic diagram illustrating the fourth process. First, the side margin sheet 404 is placed on an elastic plate to face the side surfaces S1 of the stack pieces 50.

The side margin sheet 404 may be made of any of various ceramic dielectric materials, similarly to the ceramic sheets 400 prepared in the first process. For example, the side margin sheet 404 is made of the same material as the ceramic sheets 400. The side margin sheet 404 is produced with, for example, a roll coater or a doctor blade.

The side surfaces S1 of the stack pieces 50 are then pressed against the side margin sheet 404 to cut out the side margin sheet 404. The stack pieces 50 are then lifted, with cut pieces from the side margin sheet 404 being attached to the side surfaces S1 of the stack pieces 50 and separated from the elastic plate. The resultant stack pieces 50 include the side surfaces S1 coated with the respective pieces of the side margin sheet 404, which are to be the side margins 22 after firing.

The pieces of the side margin sheet 404 may be formed on the side surfaces S1 of the stack pieces 50 in a manner other than the above cutting manner. For example, the side margin sheet 404 may be cut into pieces, which may then be attached to the side surfaces S1 of the stack pieces 50. In some embodiments, the side margins 22 after firing may be formed by applying a ceramic paste containing dielectric ceramic to the side surfaces S1 of the stack pieces 50, without using the side margin sheet 404. In this case, the ceramic paste may be applied by, for example, dip coating.

### Second Etching in Fifth Process

In the fifth process, the side surfaces S2 of the stack pieces 50 are etched by irradiation with plasma ions accelerated under a reduced pressure.

In the fifth process, the surface layers of the side surfaces S2 may be removed in the same or similar manner as the surface layers of the side surfaces S1 in the third process. For example, the fifth process may use the same plasma ion irradiator 7 for etching as in the third process. In the fifth process, the side surfaces S2 of the stack pieces 50 are irradiated with plasma ions accelerated by the plasma ion irradiator 7.

In the fifth process, the extended portions E, the foreign objects F, or other such factors included in the surface layers of the side surfaces S2 are removed. This reduces short-circuiting between the first conductors 411 and the second conductors 412 on the side surfaces S2 of the stack pieces 50.

### Forming Second Side Margins in Sixth Process

In the sixth process, the side margins 22 containing a ceramic dielectric are formed on the respective side surfaces S2 of the stack pieces 50 after being etched in the fifth process.

In the sixth process, the side margins 22 may be formed on the side surfaces S2 in the same or similar manner as the side margins 22 formed on the side surfaces S1 in the fourth process. In the sixth process, for example, the side surfaces S2 of the stack pieces 50 may be pressed against the side margin sheet 404 to be coated with pieces of the side margin sheet 404, which are to be the side margins 22 after firing.

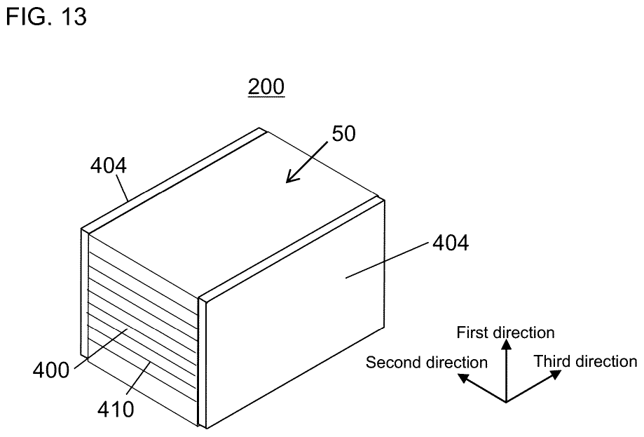

Through the above processes, the component body precursor 200 illustrated in FIG. 13 is obtained. The component body precursor 200 is to be the component body 2 after firing. The component body precursor 200 may have any shape and size appropriate for the shape and the characteristics of the component body 2 after firing.

### Firing in Seventh Process

In the seventh process, the unfired component body precursor 200 obtained through the above processes is fired to produce the component body 2 illustrated in FIGS. 2A and 2B. The firing may be performed in, for example, a reducing atmosphere or an atmosphere with a low oxygen partial pressure.

### Forming External Electrodes in Eighth Process

In the eighth process, the external electrodes 3 are formed on the end faces of the component body 2 obtained in the seventh process.

In the eighth process, an unfired electrode material is first applied to cover both end faces of the component body 2 in the third direction. The unfired electrode material applied to the component body 2 is baked in, for example, a reducing atmosphere or an atmosphere with a low oxygen partial pressure to form an underlying film on the component body 2. The baked underlying film on the component body 2 is coated with an intermediate film and a surface film by plating such as electrolytic plating, thus forming the external electrodes 3.

The eighth process may be performed partly before the seventh process. For example, before the seventh process, the unfired electrode material may be applied to both end faces of the unfired component body precursor 200 in the third direction. In the seventh process, the unfired electrode material may be baked simultaneously with firing of the component body precursor 200 to form the underlying layer for the external electrodes 3.

Through the first to eighth processes described above, the multilayer ceramic electronic component 1 illustrated in FIG. 1 is obtained.

### Examples

Table 1 below shows the evaluated characteristics of the multilayer ceramic electronic components 1 produced through the above processes. Table 1 shows the results for 10 sample Nos. 1 to 10. Sample Nos. 1 and 2 are multilayer ceramic electronic components in comparative examples, and sample Nos. 3 to 10 are the multilayer ceramic electronic components 1 in the working examples.

Table 1 shows different parameters for different samples in the third process. The parameters are the pressure (Pa), the voltage (V) for accelerating plasma ions, the time (seconds, or s) for irradiation with plasma ions, and the irradiation direction of plasma ions. The irradiation direction of plasma ions is indicated by an irradiation angle (°). The irradiation angle (°) is the angle of the irradiation direction of plasma ions with respect to the direction perpendicular to the side surfaces of the stack pieces 50.

As described above, for example, the extended portions E, the foreign objects F, or other such factors containing conductive particles can be located on the ceramic sheets 400 on the side surfaces of the stack pieces 50 after the second process. Table 1 shows the ratio of the number of conductive particles located on the ceramic sheets 400 on the side surfaces of the stack pieces 50 for each sample. This ratio is referred to as a misplaced conductive particle ratio (%).

The misplaced conductive particle ratio may be calculated in the manner described below. First, the number (hereafter referred to as a reference number) of conductive particles located on the ceramic sheets 400 on the side surfaces of the stack pieces 50 is counted for sample No. 1. The number of conductive particles located on the ceramic sheets 400 on the side surfaces of the stack pieces 50 is then counted for each of the other samples. The ratio of the number is calculated in relation to the reference number being 100%. For example, a lower misplaced conductive particle ratio (%) indicates a smaller number of conductive particles located on the ceramic sheets 400 on the side surfaces of the stack pieces 50 than the reference number. This indicates fewer extended portions E, fewer foreign objects F, or fewer such factors.

Table 1 also shows the short-circuiting ratio (%) of the multilayer ceramic electronic components for each sample. The short-circuiting ratio indicates the number of multilayer ceramic electronic components having short-circuiting out of 100 multilayer ceramic electronic components. Although the causes of short-circuiting in the multilayer ceramic electronic components can vary, Table 1 shows the ratio of short-circuiting caused by the cutting process.

For sample No. 1 in the comparative example, no etching with plasma ions was performed on the side surfaces of the stack pieces 50 resulting from cutting in the second process. In other words, the third process and the fifth process were not performed for sample No. 1.

For sample No. 2 in the comparative example, the etching was performed with plasma ions under a pressure of 0.1 MPa. In other words, sample No. 2 underwent etching with plasma ions under the atmospheric pressure, rather than under a reduced pressure.

For sample Nos. 3 to 10 in the working examples, the etching was performed with plasma ions in the third process and the fifth process under varied conditions. For the pressure, for example, sample No. 3 was set to 0.4 Pa, and sample Nos. 4 to 10 were set to 0.2 Pa.

For the voltage for accelerating plasma ions, for example, sample Nos. 2 to 5 and 9 were set to 200 V, sample Nos. 6, 7, and 10 were set to 3000 V, and sample No. 8 was set to 4000 V.

For the time of irradiation with plasma ions, for example, sample Nos. 2 to 4, 6, 9, and 10 were set to 30 seconds, and sample Nos. 5, 7, and 8 were set to 180 seconds.

For the irradiation angle of plasma ions, for example, sample Nos. 2 to 8 were set to 90°, and sample Nos. 9 and 10 were set to 45°. In other words, the irradiation direction of plasma ions for sample Nos. 2 to 8 was perpendicular to the side surfaces of the stack pieces 50, and the irradiation direction of plasma ions for sample Nos. 9 and 10 was at an angle of 45° with respect to the direction perpendicular to the side surfaces of the stack pieces 50.

TABLE 1

| | | | | | | Misplaced | |
|---|---|---|---|---|---|---|---|
| | Third and | Conditions for etching with plasma ions | | | | conductive | Short- |
| Sample | fifth | Pressure/ | Voltage/ | Time/ | Irradiation | particle | circuiting |
| No. | processes | Pa | V | s | angle/° | ratio/% | ratio/% |
| No. 1 | No | — | — | — | — | 100 | 100 |
| No. 2 | Yes | 0.1M | 200 | 30 | 90 | 99 | 98 |
| No. 3 | Yes | 0.4 | 200 | 30 | 90 | 58 | 61 |
| No. 4 | Yes | 0.2 | 200 | 30 | 90 | 45 | 43 |
| No. 5 | Yes | 0.2 | 200 | 180 | 90 | 16 | 12 |
| No. 6 | Yes | 0.2 | 3000 | 30 | 90 | 22 | 21 |
| No. 7 | Yes | 0.2 | 3000 | 180 | 90 | 3 | 0 |
| No. 8 | Yes | 0.2 | 4000 | 180 | 90 | 5 | 2 |
| No. 9 | Yes | 0.2 | 200 | 30 | 45 | 16 | 11 |
| No. 10 | Yes | 0.2 | 3000 | 30 | 45 | 0 | 0 |

Table 1 shows that sample Nos. 3 to 10 in the working examples of the present disclosure have lower misplaced conductive particle ratios and lower short-circuiting ratios than sample No. 1 in the comparative example, which underwent no etching with plasma ions, and than sample No. 2 in the comparative example, which underwent etching with plasma ions under the atmospheric pressure. The method according to one or more embodiments of the present disclosure can thus manufacture multilayer ceramic electronic components with reduced short-circuiting.

The results also reveal that sample No. 4 etched with plasma ions under a pressure lower than or equal to 0.2 Pa has a lower misplaced conductive particle ratio and a lower short-circuiting ratio than sample No. 3. Under a lower pressure, the plasma ions accelerated for irradiation are less likely to collide with the atmospheric molecules. The side surfaces of the stack pieces 50 are thus hit by the plasma ions at high speed and can be etched effectively.

The results also reveal that sample No. 6 with plasma ions accelerated at a voltage of 3000 V has a lower misplaced conductive particle ratio and a lower short-circuiting ratio than sample No. 4 with plasma ions accelerated at a voltage of 200 V. When the plasma ions are accelerated at a high voltage, the side surfaces of the stack pieces 50 are hit by the plasma ions at high speed and can be etched effectively.

However, for sample No. 8 with plasma ions accelerated at a voltage of 4000 V, the etch residues may be greatly scattered and are more likely to adhere to the side surfaces of the stack pieces 50 again. Further, for sample No. 8, the high voltage may charge the side surfaces of the stack pieces 50 with electricity and is more likely to cause the etch residues to adhere to the side surfaces again. When the plasma ions are accelerated at a voltage higher than or equal to 4000 V, the etch residues are thus more likely to adhere to the side surfaces again, possibly causing short-circuiting.

The results also reveal that sample No. 7 irradiated with plasma ions for 180 seconds has a lower misplaced conductive particle ratio and a lower short-circuiting ratio than sample No. 6 irradiated for 30 seconds. The side surfaces of the stack pieces 50 irradiated with plasma ions for a longer time can be etched more reliably.

The results also reveal that sample No. 10 with the irradiation angle of plasma ions of 45° has a lower misplaced conductive particle ratio and a lower short-circuiting ratio than sample No. 6 with the irradiation angle of 90°. When the irradiation direction of plasma ions is at an angle with respect to the direction perpendicular to the side surfaces of the stack pieces 50, the etch residues are less likely to be scattered and adhere to the side surfaces again. When the irradiation angle of plasma ions is 45°, the etch residues are less likely to be scattered in the traveling direction of the plasma ions and thus the plasma ions are less likely to decelerate than when the irradiation angle is 90°. The side surfaces of the stack pieces 50 can thus be etched more effectively.

The irradiation angle of plasma ions may not be precisely 45°. For example, the irradiation angle of plasma ions may be 20 to 70°. At such irradiation angles, the residues are less likely to be scattered and adhere to the side surfaces again, and the plasma ions are also less likely to decelerate.

The method described above can manufacture multilayer ceramic electronic components with reduced short-circuiting in the internal electrodes. The method can thus manufacture multilayer ceramic electronic components with high moisture resistance.

The present disclosure may be implemented in embodiments 1 to 9 below.
1. A method for manufacturing a multilayer ceramic electronic component, the method comprising:
preparing a stack of a plurality of ceramic sheets and a plurality of conductors alternately stacked on one another;
cutting the stack into stack pieces, each of the stack pieces including a side surface on which the plurality of conductors is exposed;
etching the side surface of each of the stack pieces by irradiation with plasma ions accelerated under a reduced pressure; and
forming a side margin comprising a ceramic dielectric on the side surface of each of the stack pieces after the etching.
2. The method according to embodiment 1, wherein
the plasma ions include Ar ions, He ions, Kr ions, Xe ions, N₂ ions, or O₂ ions.
3. The method according to embodiment 1 or embodiment 2, wherein
the reduced pressure is lower than or equal to 0.4 Pa.
4. The method according to any one of embodiments 1 to 3, wherein
the reduced pressure is lower than or equal to 0.2 Pa.
5. The method according to any one of embodiments 1 to 4, wherein
the etching is performed by irradiation with the plasma ions accelerated at a voltage higher than or equal to 200 V and lower than 4000 V.
6. The method according to any one of embodiments 1 to 5, wherein
the etching is performed by irradiation with the plasma ions accelerated at a voltage higher than or equal to 3000 V and lower than 4000 V.
7. The method according to any one of embodiments 1 to 6, wherein
the etching is performed by irradiation with the plasma ions for 30 to 180 seconds inclusive.
8. The method according to any one of embodiments 1 to 7, wherein
the etching is performed by irradiation with the plasma ions in an irradiation direction at an angle with respect to a direction perpendicular to the side surface.
9. The method according to embodiment 8, wherein
the irradiation direction is at an angle of 20 to 70° with respect to the direction perpendicular to the side surface.

Although embodiments of the present disclosure have been described in detail, the present disclosure is not limited to the embodiments, and may be changed or varied in various manners without departing from the spirit and scope of the present disclosure. The present disclosure is not limited to the examples described above.

### REFERENCE SIGNS

1 multilayer ceramic electronic component
2 component body
200 component body precursor
21 multilayer portion
211 dielectric layer
212 internal electrode layer
22 side margin
23 cover
3, 3a, 3b external electrode
400 ceramic sheet
404 side margin sheet
410 conductor
50 stack piece
500 stack
6 cutting blade
7 plasma ion irradiator

1. A method for manufacturing a multilayer ceramic electronic component, the method comprising:
preparing a stack of a plurality of ceramic sheets and a plurality of conductors alternately stacked on one another;
cutting the stack into stack pieces, each of the stack pieces including a side surface on which the plurality of conductors is exposed;
etching the side surface of each of the stack pieces by irradiation with plasma ions accelerated under a reduced pressure; and
forming a side margin comprising a ceramic dielectric on the side surface of each of the stack pieces after the etching.

2. The method according to claim 1, wherein
the plasma ions include Ar ions, He ions, Kr ions, Xe ions, N₂ ions, or O₂ ions.

3. The method according to claim 1, wherein
the reduced pressure is lower than or equal to 0.4 Pa.

4. The method according to claim 1, wherein
the reduced pressure is lower than or equal to 0.2 Pa.

5. The method according to claim 1, wherein
the etching is performed by irradiation with the plasma ions accelerated at a voltage higher than or equal to 200 V and lower than 4000 V.

6. The method according to claim 1, wherein
the etching is performed by irradiation with the plasma ions accelerated at a voltage higher than or equal to 3000 V and lower than 4000 V.

7. The method according to claim 1, wherein
the etching is performed by irradiation with the plasma ions for 30 to 180 seconds inclusive.

8. The method according to claim 1, wherein
the etching is performed by irradiation with the plasma ions in an irradiation direction at an angle with respect to a direction perpendicular to the side surface.

9. The method according to claim 8, wherein
the irradiation direction is at an angle of 20 to 70° with respect to the direction perpendicular to the side surface.
